(19) United States
(12) Patent Application Publication
(10) Pub. No.: US 2023/0410029 A1
(43) Pub. Date: Dec. 21, 2023

(54) WAREHOUSE SYSTEM FOR ASSET TRACKING AND LOAD SCHEDULING

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 18/318,102

(22) Filed: May 16, 2023

Related U.S. Application Data
(60) Provisional application No. 63/364,847, filed on May 17, 2022.

(51) Int. Cl. G06Q 10/0833

(52) U.S. Cl. CPC G06Q 10/0833

(57) ABSTRACT

Techniques are described for providing an inventory scheduling system that tracks inventory assets as the assets arrive, are stored, and depart a facility. The scheduling system may also schedule facility events in substantially real-time as the assets and/or vehicles are enroute to the facility.

### CROSS-REFERENCE TO RELATED APPLICATION(S)

This application claims priority to U.S. Provisional Application No. 63/364,847 filed on May 17, 2022 and entitled “Warehouse System for Asset Tracking and Load Scheduling,” which is incorporated herein by reference in its entirety.

### BACKGROUND

Storage facilities, such as shipping yards, processing plants, warehouses, distribution centers, ports, yards, transports, and the like store vast quantities of assets over a period of time. In some cases, as the facility becomes busy or full, assets that are scheduled to be loaded and shipped may become lost or remain on vehicles awaiting unloading, causing further delay and other inefficiencies with regards to the operations of the facilities. In some case, locating the desired assets may require walking a yard to locate a specific vehicle, container, or the like, either via an asset tracking tag or via a manual inspection process both of which are time consuming.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a scheduling system and platform for performing check in and check out processes associated with a facility, according to some implementations.

FIG. 2 is a flow diagram illustrating an example process associated with scheduling operations at a facility, according to some implementations.

FIG. 3 is a flow diagram illustrating an example process associated with scheduling operations at a facility, according to some implementations.

FIG. 4 is another flow diagram illustrating an example process associated with scheduling operations at a facility, according to some implementations.

FIG. 5 is an example system that may implement the techniques described herein according to some implementations.

### DETAILED DESCRIPTION

Discussed herein are systems and devices for automating the tracking, monitoring, and scheduling of facility events, including the loading and unloading of assets at a facility, such as a storage facility, shipping yard, processing plant, warehouse, distribution center, port, rail yard, rail terminal, and the like. In some examples, a scheduling system may be configured to track the location, age, and other statuses associated with assets, vehicles, containers and the like. For instance, the system may be configured to track assets that are stored at the facility (e.g., at a preparation area, holding area, storage area, on the vehicles parked at the facility, and the like).

The system may also track assets as the assets are moved about the facility, loaded and/or unloaded from one or more vehicles and/or containers. For instance, the system may receive sensor data associated with loading and/or unloading operations (e.g., the sensors may be associated with the loading/unloading areas, transportation vehicles, such as a forklift, and/or attached to facility operators). The system may also receive sensor data (e.g., location data, image data, and the like) associated with vehicles arriving and departing the facility as well as during the loading and unloading of the vehicles (e.g., via an exit or entry location sensor system). In some cases, the system may also receive location data and/or asset data from one or more vehicles scheduled to make a delivery to the facility and/or accept a shipment from the facility, for instance, as the vehicle is loading and/or departing with a delivery, in transit to the facility, and/or arriving.

In some cases, the system may also store or receive asset and/or scheduling data associated with scheduled events, including shipments and/or deliveries from, for instance, third-party systems. For example, the system may receive lists of assets to be shipped from (e.g., departing) the facility and/or delivered to (e.g., arriving at) the facility. In this manner, the system may store the location and status of each asset arriving at the facility, stored at the facility, and departing the facility.

As an illustrative example, if a vehicle arrives at the facility, the system may have a list of assets stored on the vehicle and check-in the vehicle via sensor data of the vehicle captured as the vehicle arrives. In some cases, the system may determine the vehicle cannot be unloaded (e.g., due to space restraints, bay door restraints, personnel restraints, and the like). In these cases, the vehicle may be directed to a holding yard where the vehicle may park and/or a container, trailer, pallet or the like may be decoupled from the vehicle and left unloaded or remain loaded or full. In this case, the system may record the location of the vehicle and/or the container, trailer, pallet within the facility yard, as the location for each of the assets assumed to be present within the vehicle, the container, trailer, pallet, the like.

In some cases, the system may note that receipt of the assets has not been accepted or confirmed for transfer of responsibility of the assets between the vehicle and the facility or the originating venue and the facility. The system may then record the confirmation or acceptance of the assets when the vehicle, the container, trailer, pallet, the like is later unloaded and the assets may be confirmed. For instance, the system may record the status of the assets as received but not confirmed until the assets are unloaded. In this manner, the system may have multiple asset statuses, such as unreceived, received and unaccepted, received and accepted, rejected. In some cases, the system may also note if the assets are damaged upon an unloading event together with the received/accepted status.

However, if the vehicle and/or container is unloaded, the system may track via sensor data associated with the unloading area, the unloading equipment (e.g., a forklift or the like), on personnel, or associated with the vehicle. The system may then store and/or record a location the assets are stored within the facility and any status data associated with the assets (e.g., received, accepted, damage, age, container quality, and the like).

The system may also track the assets as the assets are loaded onto a vehicle for shipment via sensor data associated with the loading area, the loading equipment (e.g., a forklift or the like), on personnel, or associated with the vehicle. The system may then store, update, and/or record a location the assets are leaving the facility and any status data associated with the assets as the assets depart the facility.

In this manner, the system may have sensor data and location data as well as status data for each asset on premise and arriving and/or departing the facility during operations. Accordingly, the system may be configured to schedule loading and unloading operations based on the availability, location, access, and complexity of the loading operations as well as estimated operation and delivery times. For example, the system may have three shipments schedule to depart the facility, a first shipment schedule to depart first, a second shipment schedule to second, and a third shipment schedule to third.

The facility may also only have two loading/unloading bays. However, first assets associated with the first shipment may still be within a container on the yard waiting unloading and assets associated with the second shipment may be arriving later in the day. Thus, the system discussed herein, may first schedule the loading event of the third vehicle as the third assets are present and available via the first bay. The system may also schedule the unloading event of the first assets from the container at the second bay.

The system may also estimate based on location data of the delivery vehicle the arrival time of the second assets as well as an operation time associated with the first bay and the second bay. The system may then schedule the unloading event of the second assets at the first bay and a loading of the second assets at the second bay (e.g., the assets may be unloaded and then reloaded) based at least in part on the location of the first bay and the second bay, the estimated arrival time, and the estimated operation time of the original operations (e.g., the loading of the third vehicle and the unloading of the first assets). In some cases, the system may utilize one or more machine learned models to assist in estimating arrival times and/or one or more machine learned models in scheduling events (such as unloading events, loading events, or the like). In some cases, the one or more machine learned models to assist in estimating arrival times may be trained using sensor data and/or location data associated with the vehicles as well as historical schedule data, arrival data, event time data (e.g., assets type data, vehicle type data, load/unload time data).

The system may also schedule the loading event of the first assets at the first bay following the unloading event of the delivery of the second assets. In this manner, the third vehicle may depart first, the second vehicle may depart second, and the first vehicle may depart third, however, the down time of the facility and combined departure/loading time of the combined three vehicles may be improved.

For instance, given the above example, a conventional facility operator may have initially scheduled the first vehicle to be loaded at the first bay and the third vehicle to be loaded at the second bay as the facility operator may wait to schedule the second vehicle until the arrival of the assets. However, as the first assets are in a container on the yard, the loading event of the first vehicle may be delayed as the assets are located or have a known location. Thus, the departure of the first vehicle is delayed as the assets are located and then unloaded while the first vehicle occupies the first bay. Once the assets are located and the third vehicle departs, the facility operator may have the container unloaded via the second bay. In this example, if the second assets arrive the delivery vehicle must wait as both bays are occupied, causing further delay. Once the first assets are unloaded from the container, the second assets may be unloaded via the second bay. Thus, the second vehicle is delayed until either the first vehicle is loaded and/or the second assets are unloaded. Additionally, the first bay is occupied by the first vehicle for the majority of the day and the first bay crew may be idle. Further, in the conventional system, if the delivery vehicle cannot wait for the open bay door, the vehicle may drop the container or trailer in the yard, which often causes further delay as the container again must be located by the facility operators and moved into position once the door is open and available.

Accordingly, the scheduling system, discussed herein, may utilize location data associated with a vehicle to estimate arrival time of deliveries. The system may also estimate operation times associated with each unloading and loading event based on the type of operation, the location of the assets, and the like. The system may also determine the location and/or accessibility of the assets and/or alternative assets (e.g., more accessible assets) based on sensor data and tracking data of the assets. The system may then schedule use of the loading and unloading areas (e.g., the bay doors) based on an optimization to improve the overall flow of assets in and out of the facility. As discussed above, the system may utilize one or more machine learned models and/or networks to assist in tracking assets, estimating operation and delivery times, and/or scheduling operations.

As additional illustrative examples, the system may schedule assets to remain in a prep-area opposed to being placed in a storage or shelving area when the assets will be reloaded shortly. The system may schedule reloading or unloading of containers in the yard when space in the facility is limited. For instance, if the facility storage if full, the system may utilize down time to schedule an unloading/reloading event or operation to unload assets that are low in inventory while reloading the containers with assets that have a high inventory count or the system determines will not be used as quickly as the unloaded assets. Thus, while the system may cause additional loading and unloading operations or events, the system may utilize the additional operations to improve the overall flow of assets in and out of the facility.

In some examples discussed herein, the sensors may be internet of things (IoT) computing devices that may be equipped with various sensor and/or image capture technologies, and configured to capture, parse, and identify vehicle and container information from the exterior of vehicles, containers, pallets, and the like. The vehicle and container information may include shipping documents, such as BOL (Bill of Lading), packing lists, container identifiers, chassis identifiers, vehicle identifiers, and the like. The IoT computing devices may also capture, parse, and identify driver information in various formats, such a driver licenses, driver's identification papers, facial features and recognition, and the like.

As discussed above, the system may include multiple IoT devices at various locations as well as cloud-based services, such as cloud-based data processing. One or more IoT computing device(s) may be installed at entry and/or exit points of a facility. The IoT computing devices may include a smart network video recorder (NVR) or other type of EDGE computing device. Each IoT device may also be equipped with sensors and/or image capture devices usable at night or during the day. The sensors may be weather agnostic (e.g., may operate in foggy, rainy, or snowy conditions), such as via infrared image systems, radar based image systems, LIDAR based image systems, SIWIR based image systems, Muon based image systems, radio wave based image systems, and/or the like. The IoT computing devices and/or the cloud-based services may also be equipped with models and instructions to capture, parse, identify, and extract information from the vehicles, containers, and/or various documents associated with the logistics and shipping industry. For example, the IoT computing devices and/or the cloud-based services may be configured to perform segmentation, classification, attribute detection, recognition, document data extraction, and the like. In some cases, the IoT computing devices and/or an associated cloud-based service may utilize machine learning and/or deep learning models to perform the various tasks and operations.

In some cases, since the sensor data received may be from different sources or types of sensors at different ranges and generalities, the IoT computing devices may perform a data normalization using techniques such as threshold-based data normalization and machine learning algorithms to identify the driver, vehicle, or container. It should be understood that the system may utilize different weighted averages or thresholds based on the data source (e.g., sensor type, location, distance, and position), the current weather (e.g., sunny, rainy, snowy, or foggy), and time of day when performing data normalization. In some cases, machine learning algorithms may also be applied to remove the distortion from images caused by rain, dust, sand, fog, and the like as well as to brighten the sensor and/or images shot in low-light or dark conditions.

As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

In some implementations, the IoT computing devices may also be configured to estimate one or more statuses of the contents of the containers, crates, and the like as the vehicles enter and exit the facility. For example, the IoT computing devices may use various types of a sensors (e.g., LIDAR, SIWIR, Radio Wave, Muon, etc.), with capabilities such as but not limited to varying fields of view, along with the camera or image systems and edge computing capabilities to detect various attributes such as container damage, leakage, size, weight, and the like of a vehicle, chassis, and/or container. In this manner, the IoT computing devices may operate as part of a network, IoT, colocation, Wi-Fi, local-zones, Bluetooth Low Energy, or the like to provide a comprehensive diagnostic of the physical attributes of a vehicle, truck, trailer, chassis, rail car, cargo, ship, and/or container during entry and exit of the facility. In some cases, the IoT computing devices and/or the cloud-based services may be used to identify vehicles, chassis, and/or containers that require maintenance prior to further deployment.

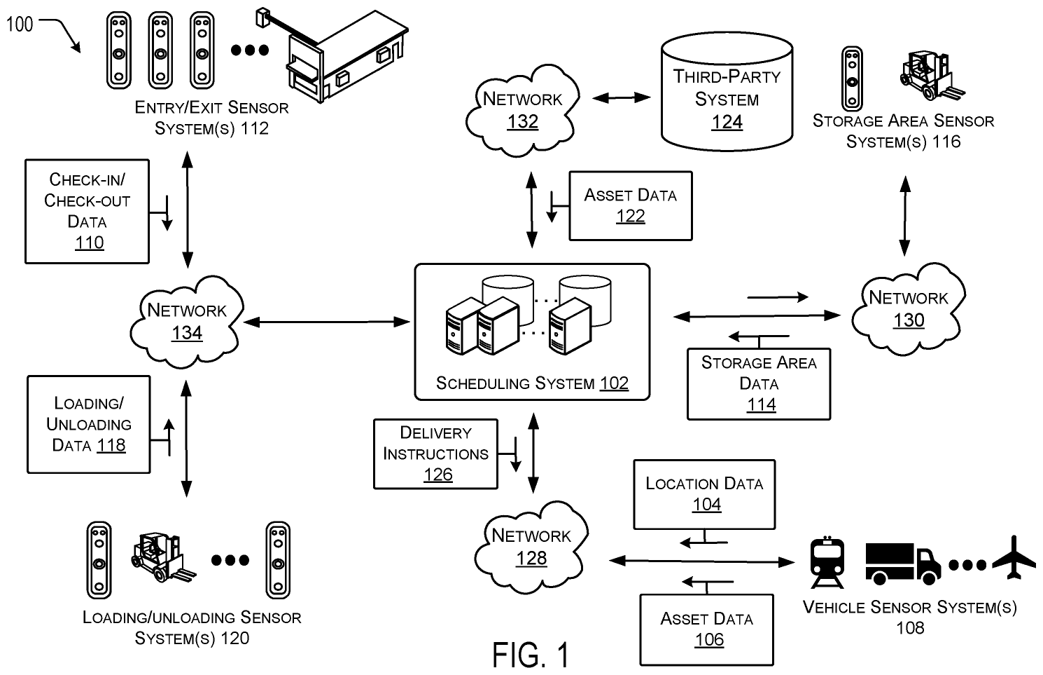

FIG. 1 is an example block diagram 100 of a scheduling system 102 for performing check in and check out processes at associated with a facility, according to some implementations. In the current example, the scheduling system 102 may be configured to schedule loading and unloading operations and/or events associated with the facility to improve the flow of assets and vehicles in and out of the facility. The scheduling system 102 may also be configured to track a location and status of the assets that are located within the facility (e.g., within a loading/unloading area, within a container or trailer, in a yard, on a shelf, on a vehicle, or at other temporary storage locations). In this manner, the system 102 may schedule operations to reduce down time and delay as well as reduce the likelihood of lost assets and/or reduce time associated with locating the lost assets.

In the illustrated example, the scheduling system 102 may be configured to receive location data 104 and asset data 106 associated with vehicles 108 delivering assets to or accepting shipments from the facility. The location data 104 and asset data 106 may be updated in substantially-real time such as the vehicle is in transit to or from the facility. In some cases, the location data 104 may be associated with global position system (GPS) data, wireless or cellular mobile network data (of the vehicle or a mobile device associated with the vehicle or delivery personnel), or the like.

The system 102 may also receive check-in and/or check-out data 110 from entry/exit sensor systems 112 as the vehicles 108 enter and exit the facility. The check-in and/or check-out data 110 may include vehicle identification information, driver or delivery personal identification information, government registration information, or the like.

The system 102 also receives storage area data 114 from the storage area sensor system 116 (e.g., sensors mounted on the facility, storage racks, equipment, personnel, and the like) as well loading/unloading data 118 from loading/unloading sensor systems 120 (e.g., sensors mounted on the facility, bay doors, equipment, personnel, and the like). In some cases, the system 102 may receive the identification data for the event personnel or other input data within the storage data 114 via an input system at the loading/unloading area.

In some examples, the scheduling system 102 may also receive asset data 122 from third-party systems 124, such as sellers, buyers, transportation companies, government authorities, other facilitates, and the like. In some cases, the asset data 122 from third-party systems 124 may include bill of lading data, asset lists (e.g., type, quantity, packaging arrangements, and the like), and the like.

In some examples, the scheduling system may track and provide notifications as to the location of the assets to facility personnel and/or operators to improve the loading and unloading operations. For example, the notifications may be provided to devices assigned to facility operators or personnel based on an assignment to an event or operation (e.g., loading/unloading, packaging, picking, or the like).

The scheduling system may also be configured to estimate delivery times, unloading operation times, loading operation times, and the like via the data 104, 106, 110, 114, 118, and 122 as well as historical data (e.g., historical facility performance times), current staffing, current equipment states, facility storage capacity and utilization (e.g., more inventory may cause increased load and unloading times), number of shipments/delivery's, vehicle types, container types, jurisdictional rules (e.g., country, state, city based shipping rules, environmental rules, vehicle operation rules, and the like), and the like.

It should be understood that in some examples, the system 102 may update schedules, cancel operations, add operations or the like in substantially real-time as additional data 104, 106, 110, 114, 118, and 122 is received by the system 102. For example, the system 102 may substitute unloading or loading events between vehicles 108 based on the additional data 104, 106, 110, 114, 118, and 122 indicating that a vehicle 108 is ahead of schedule or behind schedule and the like.

In some cases, the scheduling system 102 may provide delivery instructions 126 to the vehicles 108 and/or loading/unloading instructions to facility operators based at least in part on the schedule.

In the current example, the data 104, 106, 110, 114, 118, and 122 may be transmitted to the scheduling system using networks, generally indicated by 128-134. The networks 128-134 may be any type of network that facilitates compunction between one or more systems and may include one or more cellular networks, radio, WiFi networks, short-range or near-field networks, infrared signals, local area networks, wide area networks, the internet, and so forth. In the current example, each network 128-134 is shown as a separate network but it should be understood that two or more of the networks may be combined or the same.

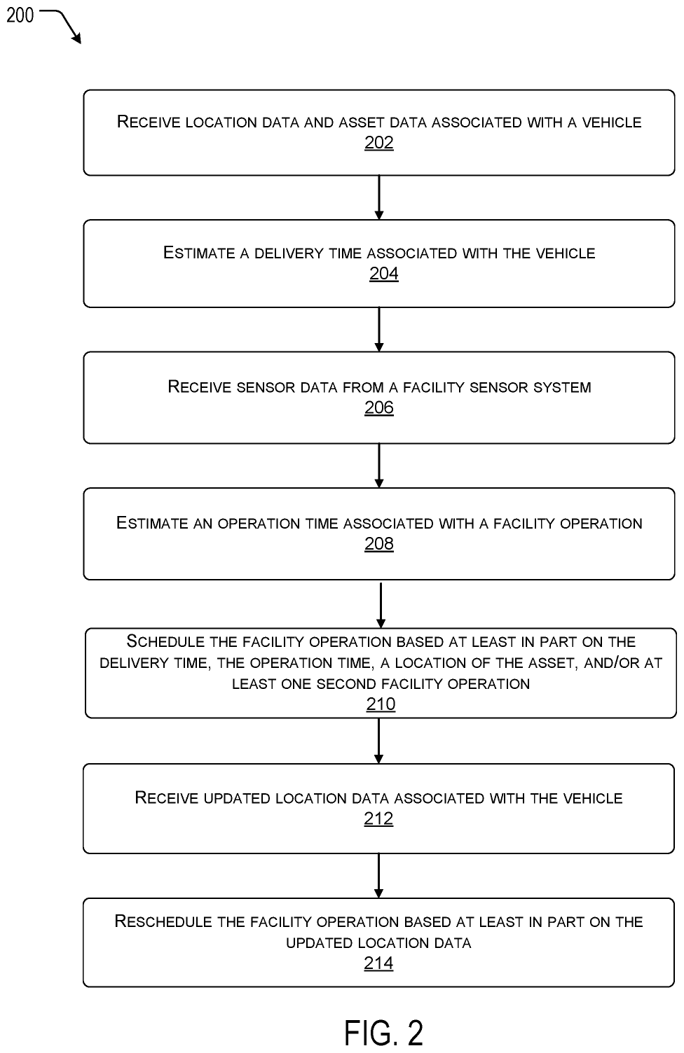

FIGS. 2 to 4 are flow diagrams illustrating example processes associated with the scheduling system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with scheduling operations at a facility, according to some implementations. As discussed herein, the scheduling system may be configured to automate scheduling of operations at a logistics facility, such as a warehouse, port, rail depot, and the like. The scheduling system may utilize sensors and/or image devices that may, in some cases, utilize cloud-based services to identify and verify vehicles, drivers, containers, as well as to capture data associated with the vehicles, drivers, containers to verify the correct parties are present as expected and track asset locations and status throughout the facility.

At 202, a scheduling system may receive location data and asset data associated with a vehicle. In some cases, the location data may be global position system (GPS) data or the like. The asset data may be associated with assets being transported by the vehicle, such as via one or more sensor systems installed with respect to a cargo area of the vehicle.

At 204, the scheduling system may estimate a delivery time associated with the vehicle. For instance, the scheduling system may utilize the location data together with any weather data, traffic data, or other known conditions associated with the route to estimate an arrival or delivery time.

At 206, the scheduling system may receive senor data from a facility sensor system, such as described above with respect to FIG. 1. For example, the system may receive sensor data from sensors equipped about the facility, associated with facility equipment and/or personnel.

At 208, the scheduling system may estimate an operation time associate with a facility operation. For example, the system may determine an estimated load time associated with one or more assets. The estimated operation time may be based at least in part on a known location, status, characteristic of the assets as well as data known about the facility, such as staffing levels, utilization levels, number of incoming deliveries or outgoing shipments, equipment type, characteristics, and status, and the like.

At 210, the scheduling system may schedule the facility operation based at least in part on the delivery time, the operation time, a location of the asset, and/or at least one second facility operation. For example, using the other pending operations, estimated times of the pending operations, the location of the assets and the estimated operation time as well as delivery or arrival times of vehicle, the scheduling system may schedule each operation to be performed. In some cases, the number of loading and unloading areas may also be used to determine the scheduling and order of the facility operations.

At 212, the scheduling system may receive updated location data associated with the vehicle and, at 214, the scheduling system may reschedule the facility operation based at least in part on the updated location data. For example, the vehicle may be delayed, the weather may change, a traffic accident may have occurred which could delay the arrival of the vehicle associated with a shipment. In these cases, the system may reschedule remaining facility operations based on the change in estimated arrival time of the vehicle.

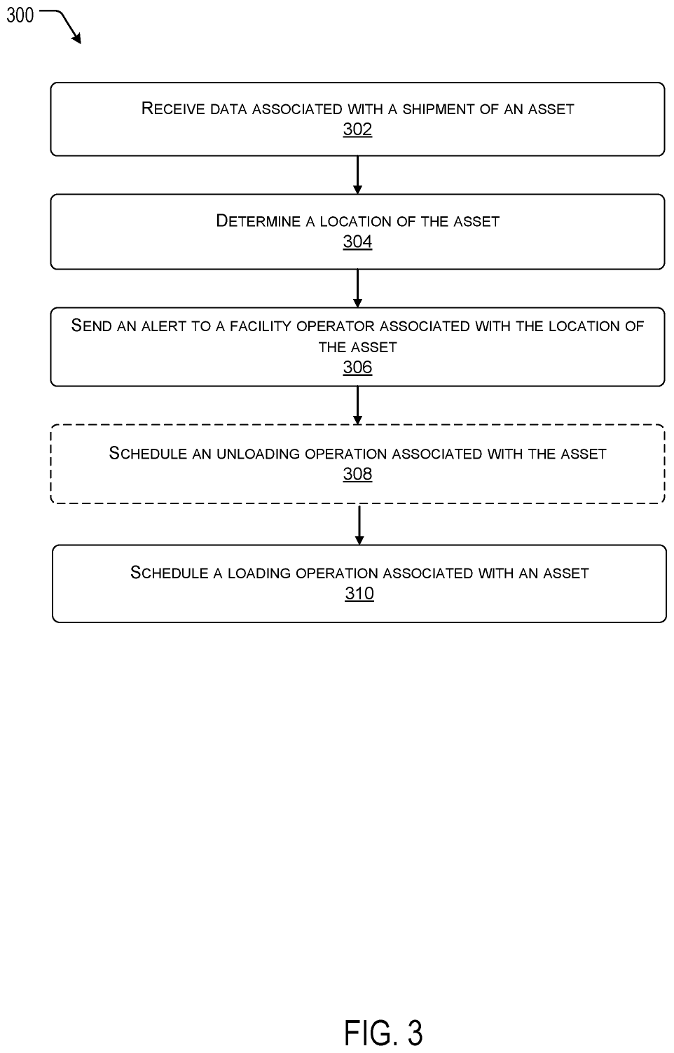

FIG. 3 is a flow diagram illustrating an example process 300 associated with scheduling operations at a facility, according to some implementations. As discussed herein, the scheduling system may be configured to automate scheduling of operations at a logistics facility, such as a warehouse, port, rail depot, and the like. The scheduling system may utilize sensors and/or image devices that may, in some cases, utilize cloud-based services to identify and verify vehicles, drivers, containers, as well as to capture data associated with the vehicles, drivers, containers to verify the correct parties are present as expected and track asset locations and status throughout the facility.

At 302, the scheduling system may receive data associated with a shipment of an asset. For example, the system may receive an order for a specified quantity of one or more assets from a third-party system or the like.

At 304, the scheduling system may determine a location of the asset. For instance, the scheduling system may track the location of assets at the facility (whether or not the asset is on a shelf, in a holding area, loaded/unloaded, or the like) using sensor data associated with assets as assets are handled by facility equipment and/or personnel.

At 306, the system may send an alert to a facility operator or personnel associated with the location of the asset. For example, the system may alert the operator or personnel that the asset is located in an unloaded trailer at a specified location within the yard. In some cases, the alert may include identifiers for the unloaded trailer, container, or vehicle. The alert may also include descriptions (e.g., color, labels, size, type, and the like), photographs, or image data of the unloaded trailer, container, or vehicle, and the like to assist the facility operator or personnel in locating the asset. The alert may also include any equipment recommended for retrieving or moving the unloaded trailer, container, or vehicle to the unloading zone or area. In some cases, the alert may also include a region associated with the facility that the assets, unloaded trailer, container, or vehicle may be located within.

At 308, the scheduling system may schedule an unloading operation associated with the asset. For instance, if the asset is already in a loading area the process 300 may advance to 310, otherwise the system may schedule a retrieval operation if the asset is within, for instance, a warehouse storage area. Otherwise, if the asset is still on a trailer, the system may schedule an unloading event for the trailer.

At 310, the scheduling system may schedule a loading operation associated with the asset. For example, once the asset is located at the loading area, the asset may be loaded onto a designated vehicle, container, or the like. In these examples, the system may record or update a status of the asset when the asset is loaded. For instance, the status may be changed to shipped, transferred, departed, or the like. In some cases, the system may also record the transit company, vehicle, or delivery personnel information or data of the collecting entity.

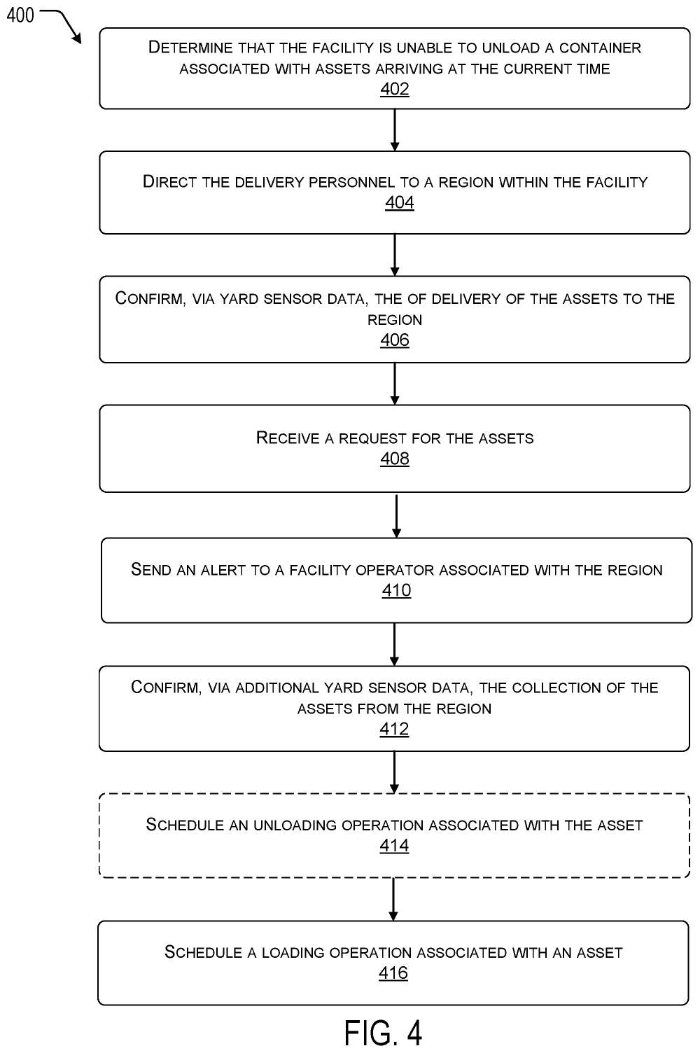

FIG. 4 is another flow diagram illustrating an example process associated with scheduling operations at a facility, according to some implementations. As discussed herein, the scheduling system may be configured to automate scheduling of operations at a logistics facility, such as a warehouse, port, rail depot, and the like, as well as maintain location data for use in locating assets within the facility, particularly assets that remain unloaded and within the container, trailer, or the like (e.g., are not located in a correct or designated area). In some cases, the scheduling system may utilize sensors and/or image devices that may, in some cases, utilize cloud-based services to identify and verify vehicles, drivers, containers, as well as to capture data associated with the vehicles, drivers, containers to verify the correct parties are present as expected and track asset locations and status throughout the facility.

At 402, the system may determine that the facility is unable to unload a container associated with assets arriving at the current time. For example, multiple vehicles may arrive at substantially concurrently, the facility may have insufficient bay doors or unloading/loading areas, the facility may have insufficient personnel or equipment available at the time of arrival, or the like.

At 404, the system may direct the delivery personnel to a region within the facility. For example, the system may send an alert of the delivery personnel via the vehicle or a mobile device associated with the system and the delivery personnel (such as via an application hosted by the mobile device). In some cases, the alert may include a map or other directions to the region to assist the delivery personnel with delivering the assets to the correct region.

At 406, the system may confirm, via yard sensor data, the delivery of the assets to the region. In some cases, the system may track or monitor the delivery personnel, via facility sensors (e.g., image data), as the vehicle traverses the facility. In this manner, the system may determine that the assets are delivered to the desired region. However, if the assets are not delivered to the desired region, the system may note the incorrect or undesirable delivery and update the location of the assets to the actual region of delivery opposed to the expected region of delivery. In this manner, the system may track the location of the assets even during mistakes or inadvertent operations, unlike conventional systems.

In some examples, the system may maintain an asset map or overlay that allows the facility operators or personnel to quickly determine the region, position, or location of the assets within the facility whether or not the assets are in an expected position. In some cases, the map or overlay may be searchable by asset data (e.g., type, quantity, characteristic, or the like). In some cases, the asset map or overlay may be three-dimensional, such for ease of viewing stacked or shelved assets within the facility. For example, multiple containers may be stacked one atop the other, such that each is within a specific or same region. By providing three-dimensional data the facility operators or personnel may be able to locate the region of the assets as well as a position of the assets (e.g., which stacked container) with reduced difficulty when compared to a conventional system.

At 408, the system may receive a request for the assets. For example, the system may receive an order for a specified quantity of one or more the assets from a third-party system or the like.

At 410, the system may send an alert to a facility operator or personnel associated with the location or region of the asset. For example, the system may alert the operator or personnel that the asset is located in an unloaded trailer at a specified region within the yard. In some cases, the alert may include identifiers for the unloaded trailer, container, or vehicle. The alert may also include descriptions (e.g., color, labels, size, type, and the like), photographs, or image data of the unloaded trailer, container, or vehicle, and the like to assist the facility operator or personnel in locating the asset. The alert may also include any equipment recommended for retrieving or moving the unloaded trailer, container, or vehicle to the unloading zone or area. In some cases, the alert may also include a region associated with the facility that the assets, unloaded trailer, container, or vehicle may be located within.

At 412, the system may confirm, via additional yard sensor data, the collection of the assets from the region. For example, the system may utilize the additional storage area sensor data to determine that the notified or other facility operator or personnel has collected the container, trailer, vehicle, or the like as well as the contained assets and moved them to an unloading area.

At 414, the scheduling system may schedule an unloading operation associated with the asset. For instance, if the asset is already in a loading area the process 300 may advance to 310, otherwise the system may schedule a retrieval operation if the asset is within, for instance, a warehouse storage area. Otherwise, if the asset is still on a trailer, the system may schedule an unloading event for the trailer. In some cases, the system may notify other facility personnel that an unloading event or operation has been scheduled for the collected or retrieved container, trailer, vehicle, or the like. Again, the system may send a notification to a mobile device associated with the desired facility personnel.

At 416, the scheduling system may schedule a loading operation associated with the asset. For example, once the asset is located at the loading area, the asset may be loaded onto a designated vehicle, container, or the like. In these examples, the system may record or update a status of the asset when the asset is loaded. For instance, the status may be changed to shipped, transferred, departed, or the like. In some cases, the system may also record the transit company, vehicle, or delivery personnel information or data of the collecting entity.

In this example, the system may cause the facility personnel to maintain the assets in the unloading/loading area without moving the assets to the storage area, as the assets will be loaded in the next scheduled event at the loading/unloading area.

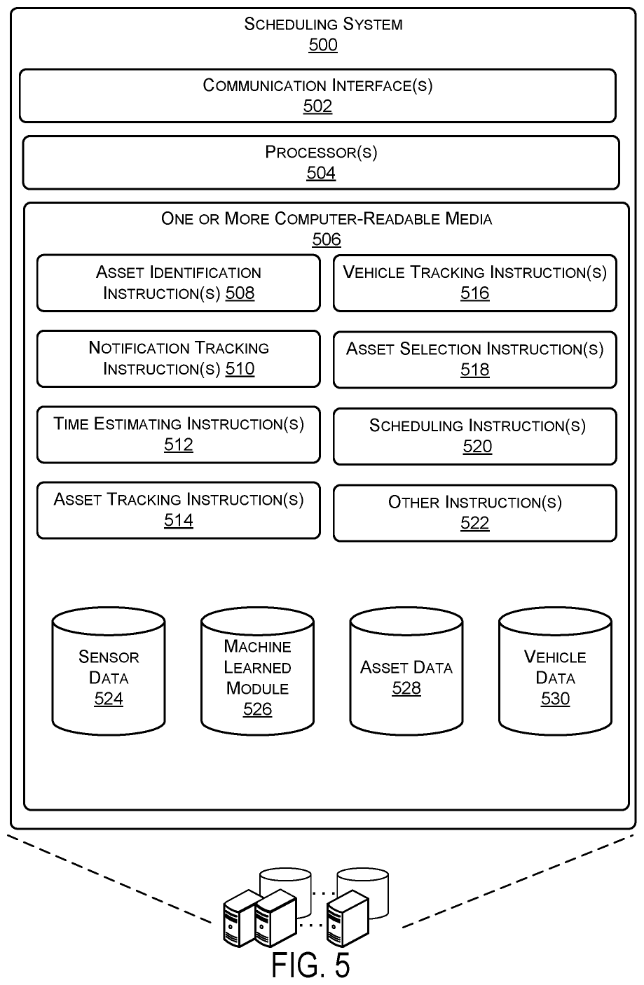

FIG. 5 is an example scheduling system 500 that may implement the techniques described herein according to some implementations. The system 500 may include one or more communication interface(s) 502 (also referred to as communication devices and/or modems), one or more processor(s) 504, and one or more computer readable media 506.

The system 500 can include one or more communication interfaces(s) 502 that enable communication between the system 500 and one or more other local or remote computing device(s) or remote services, such as a sensor system of FIG. 1. For instance, the communication interface(s) 502 can facilitate communication with other central processing systems, a sensor system, or other facility systems. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, etc.), satellite communication, dedicated short-range communications (DSRC), or any suitable wired or wireless communications protocol that enables the respective computing device to interface with the other computing device(s).

The system 500 may include one or more processors 504 and one or more computer-readable media 506. Each of the processors 504 may itself comprise one or more processors or processing cores. The computer-readable media 506 is illustrated as including memory/storage. The computer-readable media 506 may include volatile media (such as random access memory (RAM)) and/or nonvolatile media (such as read only memory (ROM), Flash memory, optical disks, magnetic disks, and so forth). The computer-readable media 506 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 506 and configured to execute on the processors 504. For example, as illustrated, the computer-readable media 506 stores asset identification instructions 508, notification instructions 510, time estimation instructions 512, asset tracking instructions 514, vehicle tracking instructions 516, asset selection instruction 518, scheduling instructions 520, as well as other instructions 522, such as an operating system. The computer-readable media 506 may also be configured to store data, such as sensor data 524, machine learned models 526, asset data 528, vehicle data 530, as well as other data.

The asset identification instructions 508 may be configured to determine the identity, status, and location of assets based on sensor data received from various sensors associated with the facility, delivery vehicles, and the like. In some cases, the asset identification instructions 508 may segment and/or classify image data of the vehicles, delivery personnel, the assets or the like to determine the identity, status, and location of assets. In some cases, the asset identification instructions 508 may also utilize third-party data, such as lists of assets arriving on various vehicles or within specified containers to determine the identity and/or status of the assets.

The notification instructions 510 may be configured to provide notifications to facility operators or personnel, vehicle operators and the like. For example, the notification instructions 510 may provide delivery instructions to vehicle operators, asset locations and schedules to facility operators, and the like. In some cases, the notifications may include location data, regions, or directions to assist the facility operators or personnel and vehicle operators in performing operations, such as deliveries, loading, unloading, and the like.

The time estimation instructions 512 may be configured to estimate arrival time and/or operation times associated with operations of the facility based at least in part on known data about the assets, vehicles, facility personnel, equipment, and the like. In some cases, the time estimation instructions 512 may utilize one or more machine learned models to assist with estimating or predicting the arrival time, operation time, or scheduling of events. In some cases, the one or more machine learned models may be trained using historical data associate with operation executing time, type, with varying personnel and equipment assigned.

The asset tracking instructions 514 may be configured to update locations or regions associated with assets as the assets are detected in the sensor data by the asset identification instructions 510. In some cases, the asset tracking instructions 514 may be configured to update location or region for assets, vehicles, containers, or the like as assets are moved, loaded, unloaded, stored or the like based on facility sensor systems (such as image data sensors).

The vehicle tracking instructions 516 may be configured to track a location of the vehicle based at least in part on the location data received. For example, the vehicle tracking instructions 516 may be configured to assist in determining the location of the vehicle and/or the estimated time of arrival for a delivery or shipment to another venue.

The asset selection instruction 518 may be configured to select assets for a loading operation based at least in part on the asset location data and the like. For example, instances of assets may be located at various different locations. In some cases, the asset selection instruction 518 may combine different stores of assets at different locations to achieve the desired quantity. In some cases, the selection of the assets may be based on the total request to be shipped from the facility. For example, the system may select nearby or relatively proximate assets over more accessible assets that are further distributed (e.g., it may be easier to unload a single container with all the assets than to collect the assets from multiple areas even when an unloading event is required in the former situation).

The scheduling instructions 520 may be configured to schedule and update a schedule associated with facility operations as discussed herein based on the data known about the facility, the assets, and vehicles. For example, the scheduling instructions 520 may update scheduled events in substantially real-time based on current locations of assets, estimated time of arrival or departure for the assets, location of the assets within the facility, available personnel or equipment, urgency or need of the assets, and the like.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### Example Clauses

A. A method comprising: receiving first location data associated with a first vehicle delivering a first asset within a first container to a facility; determining, based at least in part on first sensor data, that an unloading area of the facility is occupied; determining, based at least in part on second sensor data associated with a yard of the facility, a location within the yard; sending instructions to a device associated with a delivery personnel associated with the first vehicle to deliver the container to the location; determining, based at least in part on third sensor data associated with the yard of the facility, the delivery of the container to the location; and updating a status of the first asset to indicate a storage location of the first asset as the container at the location.

B. The method of A, wherein determining that the unloading area is occupied further comprises: estimating a time of arrival of the first vehicle based at least in part on the first location data and historical delivery data; and determining, based at least in part on the time of arrival and data associated with other deliveries, that the unloading area will be occupied at the time of arrival.

C. The method of any of A or B, further comprising: receiving second location data associated with a second vehicle delivering a second asset within a second container to the facility; scheduling, based at least in part on the first location data and the second location data, an unloading event at the unloading area for the second vehicle; and wherein determining that the unloading area of the facility is occupied is based at least in part on the unloading event associated with the second vehicle.

D. The method of the C, wherein: estimating the time of arrival of the first vehicle further comprises: inputting the first location data into one or more first machine learned models trained on historical delivery data and receiving the time of arrival as an output of the one or more first machine learned models; and scheduling the unloading event at the unloading area for the second vehicle further comprises: inputting the time of arrival into one or more second machine learned models trained on facility event data and receiving the unloading event as an output of the one or more second machine learned models.

E. The method of the D, further comprising: receiving third location data associated with a third vehicle delivering a third asset within a third container to the facility; and wherein scheduling the unloading event at the unloading area for the second vehicle is based at least in part on the third location data, data associated with the personnel of the facility, data associated with equipment of the facility, and at least one or event associated with the facility.

F. The method of any of A-E, further comprising: receiving an order from a third-party system, the order including the first asset; sending the location of the first container with the first asset to a device associated with a facility personnel; and determining, based at least in part on fourth sensor data associated with the yard of the facility, that the first container has been moved to the unloading area.

G. The method of F, wherein the unloading area is also a loading area and the method further comprising: in response to determining, based at least in part on fifth sensor data associated with the unloading area of the facility, that the first asset was present in the first container, updating the storage location of the first asset to the unloading area; and in response to determining, based at least in part on sixth sensor data associated with the unloading area of the facility, that the first asset is loading on a third vehicle, updating the storage location of the first asset to the third vehicle.

H. The method of F, wherein in response to determining, based at least in part on fifth sensor data associated with the unloading area of the facility, that the first asset has damage or a defect, sending a notification to a third-party associated with the delivery of the first asset to the facility as to the damage or the defect.

I. The method of F, wherein sending the location of the first container with the first asset to the device associated with a facility personnel further comprises sending a region and an identifier associated with the container.

J. The method of F, further comprising selecting the first asset for the order based at least in part on the location of the first asset and a second location of a third asset, the first asset and the second asset having a same type.

K. The method of F, wherein the first asset is a first plurality of the first assets and the method further comprising selecting the first plurality of the first assets for the order based at least in part on a first quantity of the first plurality of the first assets and a second quantity of a second plurality of the first assets.

L. The method of F, further comprising: estimating an unloading time associated with the first container; estimating a second time of arrival of a third vehicle, the third vehicle to collect the order; and selecting the first asset for the order based at least in part on the unloading time and the second time of arrival.

M. A computer program product comprising coded instructions that, when run on a computer, implement a method as claimed in any of A-L.

N. A system comprising: one or more processors; and one or more non-transitory computer-readable media storing instructions that, when executed by the one or more processors, cause the one or more processors to perform operations comprising: receiving first location data associated with a first vehicle delivering a first asset within a first container to a facility; determining, based at least in part on first sensor data, that an unloading area of the facility is occupied; determining, based at least in part on second sensor data associated with a yard of the facility, a location within the yard; sending instructions to a device associated with a delivery personnel associated with the first vehicle to deliver the container to the location; determining, based at least in part on third sensor data associated with the yard of the facility, the delivery of the container to the location; updating a status of the first asset to indicate a storage location of the first asset as the container at the location; receiving an order from a third-party system, the order including the first asset; sending the location of the first container with the first asset to a device associated with a facility personnel; and determining, based at least in part on fourth sensor data associated with the yard of the facility, that the first container has been moved to the unloading area.

O. The system of N, wherein the unloading area is also a loading area and the operations further comprising: in response to determining, based at least in part on fifth sensor data associated with the unloading area of the facility, that the first asset was present in the first container, updating the storage location of the first asset to the unloading area; and in response to determining, based at least in part on sixth sensor data associated with the unloading area of the facility, that the first asset is loading on a third vehicle, updating the storage location of the first asset to the third vehicle.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A method comprising:
receiving first location data associated with a first vehicle delivering a first asset within a first container to a facility;
determining, based at least in part on first sensor data, that an unloading area of the facility is occupied;
determining, based at least in part on second sensor data associated with a yard of the facility, a location within the yard;
sending instructions to a device associated with a delivery personnel associated with the first vehicle to deliver the container to the location;
determining, based at least in part on third sensor data associated with the yard of the facility, the delivery of the container to the location; and
updating a status of the first asset to indicate a storage location of the first asset as the container at the location.

2. The method of claim 1, wherein determining that the unloading area is occupied further comprises:
estimating a time of arrival of the first vehicle based at least in part on the first location data and historical delivery data; and
determining, based at least in part on the time of arrival and data associated with other deliveries, that the unloading area will be occupied at the time of arrival.

3. The method of claim 1, further comprising:
receiving second location data associated with a second vehicle delivering a second asset within a second container to the facility;
scheduling, based at least in part on the first location data and the second location data, an unloading event at the unloading area for the second vehicle; and
wherein determining that the unloading area of the facility is occupied is based at least in part on the unloading event associated with the second vehicle.

4. The method of the claim 3, wherein:
estimating the time of arrival of the first vehicle further comprises:
inputting the first location data into one or more first machine learned models trained on historical delivery data and receiving the time of arrival as an output of the one or more first machine learned models; and
scheduling the unloading event at the unloading area for the second vehicle further comprises:
inputting the time of arrival into one or more second machine learned models trained on facility event data and receiving the unloading event as an output of the one or more second machine learned models.

5. The method of the claim 4, further comprising:
receiving third location data associated with a third vehicle delivering a third asset within a third container to the facility; and
wherein scheduling the unloading event at the unloading area for the second vehicle is based at least in part on the third location data, data associated with the personnel of the facility, data associated with equipment of the facility, and at least one or more events associated with the facility.

6. The method of the claim 1, further comprising:
receiving an order from a third-party system, the order including the first asset;
sending the location of the first container with the first asset to a device associated with a facility personnel; and
determining, based at least in part on fourth sensor data associated with the yard of the facility, that the first container has been moved to the unloading area.

7. The method of the claim 6, wherein the unloading area is also a loading area and the method further comprising:
in response to determining, based at least in part on fifth sensor data associated with the unloading area of the facility, that the first asset was present in the first container, updating the storage location of the first asset to the unloading area; and
in response to determining, based at least in part on sixth sensor data associated with the unloading area of the facility, that the first asset is loaded on a third vehicle, updating the storage location of the first asset to the third vehicle.

8. The method of the claim 6, wherein:
in response to determining, based at least in part on fifth sensor data associated with the unloading area of the facility, that the first asset has damage or a defect, sending a notification to a third-party associated with the delivery of the first asset to the facility as to the damage or the defect.

9. The method of the claim 6, wherein sending the location of the first container with the first asset to the device associated with a facility personnel further comprises sending a region and an identifier associated with the container.

10. The method of the claim 6, further comprising selecting the first asset for the order based at least in part on the location of the first asset and a second location of a third asset, the first asset and the second asset having a same type.

11. The method of the claim 6, wherein the first asset is a first plurality of the first assets and the method further comprising selecting the first plurality of the first assets for the order based at least in part on a first quantity of the first plurality of the first assets and a second quantity of a second plurality of the first assets.

12. The method of the claim 6, further comprising:
estimating an unloading time associated with the first container;
estimating a second time of arrival of a third vehicle, the third vehicle to collect the order; and
selecting the first asset for the order based at least in part on the unloading time and the second time of arrival.

13. A system comprising:
one or more processors; and
one or more non-transitory computer-readable media storing instructions that, when executed by the one or more processors, cause the one or more processors to perform operations comprising:
receiving first location data associated with a first vehicle delivering a first asset within a first container to a facility;
determining, based at least in part on first sensor data, that an unloading area of the facility is occupied;
determining, based at least in part on second sensor data associated with a yard of the facility, a location within the yard;
sending instructions to a device associated with a delivery personnel associated with the first vehicle to deliver the container to the location;
determining, based at least in part on third sensor data associated with the yard of the facility, the delivery of the container to the location;
updating a status of the first asset to indicate a storage location of the first asset as the container at the location;
receiving an order from a third-party system, the order including the first asset;
sending the location of the first container with the first asset to a device associated with a facility personnel; and
determining, based at least in part on fourth sensor data associated with the yard of the facility, that the first container has been moved to the unloading area.

14. The system of claim 13, wherein the unloading area is also a loading area and the operations further comprising:
in response to determining, based at least in part on fifth sensor data associated with the unloading area of the facility, that the first asset was present in the first container, updating the storage location of the first asset to the unloading area; and
in response to determining, based at least in part on sixth sensor data associated with the unloading area of the facility, that the first asset is loaded on a third vehicle, updating the storage location of the first asset to the third vehicle.

15. One or more non-transitory computer-readable media storing instructions that, when executed by one or more processors, cause the one or more processors to perform operations comprising:
receiving first location data associated with a first vehicle delivering a first asset within a first container to a facility;
determining, based at least in part on first sensor data, that an unloading area of the facility is occupied;
determining, based at least in part on second sensor data associated with a yard of the facility, a location within the yard;
sending instructions to a device associated with a delivery personnel associated with the first vehicle to deliver the container to the location;
determining, based at least in part on third sensor data associated with the yard of the facility, the delivery of the container to the location; and
updating a status of the first asset to indicate a storage location of the first asset as the container at the location.

16. The one or more non-transitory computer-readable media of claim 15, wherein determining that the unloading area is occupied further comprises:
estimating a time of arrival of the first vehicle based at least in part on the first location data and historical delivery data; and
determining, based at least in part on the time of arrival and data associated with other deliveries, that the unloading area will be occupied at the time of arrival.

17. The one or more non-transitory computer-readable media of claim 15, wherein the operations further comprise:
receiving second location data associated with a second vehicle delivering a second asset within a second container to the facility;
scheduling, based at least in part on the first location data and the second location data, an unloading event at the unloading area for the second vehicle; and
wherein determining that the unloading area of the facility is occupied is based at least in part on the unloading event associated with the second vehicle.

18. The one or more non-transitory computer-readable media of the claim 15, wherein the operations further comprise:
receiving an order from a third-party system, the order including the first asset;
sending the location of the first container with the first asset to a device associated with a facility personnel; and
determining, based at least in part on fourth sensor data associated with the yard of the facility, that the first container has been moved to the unloading area.

19. The one or more non-transitory computer-readable media of the claim 18, wherein the unloading area is also a loading area and the method further comprising:
in response to determining, based at least in part on fifth sensor data associated with the unloading area of the facility, that the first asset was present in the first container, updating the storage location of the first asset to the unloading area; and
in response to determining, based at least in part on sixth sensor data associated with the unloading area of the facility, that the first asset is loaded on a third vehicle, updating the storage location of the first asset to the third vehicle.

20. The one or more non-transitory computer-readable media of the claim 18, wherein in response to determining, based at least in part on fifth sensor data associated with the unloading area of the facility, that the first asset has damage or a defect, sending a notification to a third-party associated with the delivery of the first asset to the facility as to the damage or the defect.
